(19) United States
(12) Patent Application Publication
(10) Pub. No.: US 2003/0005464 A1
(43) Pub. Date: Jan. 2, 2003

(54) System and method for repository storage of private data on a network for direct client access

(75) Inventors: Adrian Gropper, Watertown, MA (US); Sean Doyle, Somerville, MA (US)

Correspondence Address: TESTA, HURWITZ & THIBEAULT, LLP, HIGH STREET TOWER, 125 HIGH STREET, BOSTON, MA, 02110, US

(73) Assignee: Amicas, Inc., West Newton, MA (US)

(21) Appl. No.: 10/135,879

(22) Filed: Apr. 30, 2002

Related U.S. Application Data
(60) Provisional application No. 60/287,905, filed on May 1, 2001.
(60) Provisional application No. 60/288,950, filed on May 4, 2001.
(60) Provisional application No. 60/322,495, filed on Sep. 14, 2001.

(51) Int. Cl. H04N 7/173; G06F 15/16

(52) U.S. Cl. 725/115; 725/114; 709/219

(57) ABSTRACT

In one aspect, the invention relates to a method for storing an image or a manifest that references a number of related images in a repository. The method comprises receiving, by an importer, data, generating an identifier associated with the data, the identifier including a substantially random unique identifier, transmitting the data to a repository and transmitting the identifier to a location separate and distinct from the repository and the importer. In one embodiment, the image includes a medical image. In another embodiment, the method further includes encoding the image to a coded image. In another embodiment, the step of requesting the image further comprises requesting the image from the repository using a standards-based protocol, and the step of transmitting the image further comprises transmitting the image file using a proprietary or a standards-based protocol.

### CROSS-REFERENCE TO RELATED APPLICATIONS

This application claims the benefit of and priority to the co-pending U.S. Provisional Application, Serial No. 60/287,905, filed May 1, 2001, entitled “System and Methods for Manipulating Medical Images and Managing Workflow,” the entirety of which is incorporated herein by reference. This application also claims the benefit of and priority to the co-pending U.S. Provisional Application, Serial No. 60/288,950, filed May 4, 2001, entitled “System and Methods for Manipulating Medical Images and Managing Workflow,” the entirety of which is incorporated herein by reference. This application also claims the benefit of and priority to the co-pending U.S. Provisional Application, Serial No. 60/322,495, filed Sep. 14, 2001, entitled “System and Methods For Streaming Medical Images Using a Standards-Based Protocol,” the entirety of which is incorporated herein by reference.

### FIELD OF INVENTION

The invention relates generally to medical data management systems. More specifically, in one embodiment, the invention relates to systems and methods for storing medical images using standards-based image coding and image access protocols.

### BACKGROUND

In some known prior art systems, the archival storage of medical information in (non-physical film) electronic form is subject to problems of high cost, rapid obsolescence and inadequate security. Some systems use a central database to store images. The size of medical images prohibits these systems from scaling efficiently. Other systems distribute storage over a network, but still require a central management module to manage and retrieve the images when requested. This creates a bottleneck and there can still be scalability problems. In either case, pooling of storage (for storage management and security management convenience) for the applications of unrelated vendors is very difficult.

### SUMMARY OF THE INVENTION

The current invention addresses these problems and others, in one embodiment, by employing asymmetrical storage architecture, using commercially accepted standards where applicable. According to one embodiment, this asymmetrical storage stores the medical image in a first location and unique identifying information, including the address of the image, in another location, separate from the first location. By controlling who has access to the identifying information, the second location can be a standards-based, highly accessible repository with low or no probability of someone accidentally retrieving the image and the first location can be a pool of storage for many applications that is not specific to the proprietary needs and protocols of any single vendor. Examples of two standards for image retrieval and coding are HTTP(S) and JPEG 2000. Other such standards, however, may be employed without deviating from the scope of the invention. HTTP is the common standard for Web clients connecting, authenticating and disconnecting from Web servers. HTTPS and other security enhancements provide standards-based encryption on top of the HTTP standard. HTTP is commonly used to efficiently transfer files such as Web pages. Part of the efficiency of HTTP transfers comes from the capability to discontinue the transfer to the remainder of a file once the recipient has determined that they have received the information of interest. A further HTTP efficiency is the ability to define byte ranges where only a portion of a file is retrieved.

JPEG 2000 is a standard for coding images that can be used to order the image information in a file to suit different applications. In particular, the ordering of an image in order of resolution (from low resolution to highest resolution) makes it possible to use the same file to efficiently serve images to both low and high-resolution clients. The low-resolution clients simply discontinue the file transfer earlier than the high-resolution clients. In one aspect, the invention recognizes that the ability of HTTP clients to discontinue file transfers therefore complements the ability of JPEG 2000 standard to code image files in order of resolution and results in an efficient, standards-based image archive.

The combination of a standard Web server holding files in a standard JPEG 2000 format creates a non-proprietary system. By enabling medical images to be stored in a non-proprietary manner, the current invention promises lower cost and reduced risk of rapid obsolescence. In particular, through use of the invention, high-resolution medical images can now be stored alongside non-medical, Web-accessible content such as Web sites and music files without sacrificing efficiency of retrieval.

A further refinement of the standards-based storage is achieved by storing a list of related image files and associated meta-data on the Web server in a standards-based format such as XML. The storage of meta-data sufficient to enable efficient access to a related set of images avoids the inefficiency of unnecessary database queries or unnecessary image file retrievals. In a particular embodiment of this invention, the XML-coded file contains image lists and associated meta-data that is processed by a Java-standard Web browser to provide a high speed and feature rich user interface experience without any database queries. As a further refinement, in another embodiment, this meta-data file can be encoded to facilitate streaming by putting the most commonly required information or an index at the beginning of the file.

According to another feature, encoding the file identifiers enforces the security of image and meta-data files stored on a shared Web server. Typically, a database stores selected information about a related series of images (e.g., the images collected during a single medical imaging procedure for a patient) according to indexes such as patient name and procedure date and associates the encoded file identifier that describes the procedure and lists the images generated by the procedure.

The invention, in one embodiment, provides low cost, low risk of obsolescence and security by segregating the indexing and security functions in a database store that is separate from the file store. According to one feature, the database store and the file store can each be accessed through shared or separate Web-servers. Since the database store is typically much smaller than the associated image (and image meta-data) files, it lends itself to less costly and more convenient management. In particular, when a facility has an existing medical record management system (such as for the storage of blood test or radiology reports) the image database store can be eliminated entirely by storing the file identifier of the meta-data (or the image file) in the medical record system just like any other small piece of medical information.

To efficiently retrieve some or all of the images associated with a procedure, the file identifier (as stored in a separate database or a medical record system) is passed to an image display client such as a Java-enabled Web browser or a code module of similar functionality that has been added to a medical image display workstation.

In one aspect, the invention is related to employing a standards-based compression protocol (e.g., JPEG 2000) to stream radiological or other medical images through a Web server to client devices. In one embodiment, the invention is related to a method for streaming medical images from a data storage device to a client device using a standards-based image coding algorithm. According to one embodiment, the method includes receiving a “Digital Image Communications in Medicine” (DICOM) medical image from an image source and storing the medical image either in DICOM format or using the standards-based image coding format or a proprietary coding format. The method further includes accessing the stored medical image and streaming the stored medical image to the client device.

In a further embodiment, the method includes preprocessing the medical image prior to storing the medical image. In still another embodiment, the standards-based image coding algorithm uses the JPEG 2000 architecture. In yet another embodiment, the step of storing the medical image includes compressing the medical image. In still another embodiment, the medical image is accessed via a Web server.

In another aspect, the invention is related to a system including a database store that is separate from an electronic file store, whereby the file store is standards-based and indexed by the database store. In one embodiment, the file store provides security by encoding the identifier of the file prior to indexing in the database store. In another embodiment, the file store includes coded image files as well as coded lists of image files and associated information (meta-data) about the image files. In another embodiment, the file store provides security by encoding the identifier of the meta-data file prior to indexing in the database store.

In another embodiment, the database store is a medical record system. In another embodiment, the database store saves the meta-data file identifier as an element of a medical record system. In another embodiment, the invention encodes the meta-data in a format so that a Web server can efficiently stream it by putting the most commonly required elements or an index into the remaining elements earlier in the meta-data file. In another embodiment, the file store includes meta-data serving some or all of the following elements: patient identifiers that could be used to cross reference studies, security identifiers that could be used to restrict access, original study identifiers (e.g.: DICOM StudyInstance UID) that could be used to retrieve non-image data from another source (e.g., DICOM Key Object), original image identifiers (e.g., DICOM SOPInstance UID) that could be used to verify correct image retrieval, expiration dates that could be used to purge information as it ages, pointers to multiple copies of the same image for redundancy, and pointers to multiple versions of the same image (e.g.: lossy and lossless versions) that could be deleted separately.

In another aspect, the invention relates to one or more Web-accessible HTML standards-based file store (or stores) that archive images encoded in JPEG 2000 format and/or meta-data files encoded in XML format that include a list of associated image files. In one embodiment, the file store encodes the image and meta-data file identifiers to provide security. In another embodiment, the file store provides security by preventing “browsing” and allows file identifiers to be pseudo-random with a large enough search space so that the probability of a random search encountering any stored images is very low (i.e., substantially random identifier).

In another aspect, the invention relates to a method for storing medical image files. In one embodiment, the method includes storing an image file at a first storage location; and storing a random unique identifier (“RUID”) associated with the image file at a second storage location. In another aspect, the invention relates to a different method for storing medical image files. In a further embodiment, the method comprises receiving an image file from an image source and generating a random unique identifier associated with the image file. In an additional embodiment, the method further includes transmitting the image file to a repository and transmitting the random unique identifier to a destination separate from the repository.

In other embodiments, the methods include converting the image file from a first format to a second format. In another embodiment, the second format is a standards-based format. In another embodiment, the standards-based format conforms to the JPEG2000 standard. Another embodiment includes requesting the image file from the first storage location, using the random unique identifier stored in the second storage location. In another embodiment, the request uses a standards-based protocol. In another embodiment, the standards-based protocol conforms to the HTTP standard.

In another aspect the invention relates to a system for storing medical image files. In one embodiment, the system includes a first storage location and a second storage location, which are separate from each other. In a further embodiment, the first storage location receives an image file associated with a random unique identifier and the second storage location receives the random unique identifier. In one aspect, the invention relates to an importer for storing medical image files. In a further aspect, the importer includes an input port, a first output port and a second output port.

In one feature, the input port is in communication with an image source, and the input port is configured to receive a file from the image source. The import port can receive images in a file format, in streamed format, and/or in other non-file protocol formats (e.g., DICOM and the like). According to another feature, the first output port is in communication with a first storage location, and the first output port is configured to transmit the file to the first storage location. According to a further feature, a random unique identifier generator is in communication with the input port and optionally with the first output port, and the random unique identifier generator generates a random unique identifier and associates the random unique identifier with the received file. The second output port is in communication with a second storage location that is separate from the first storage location, and the second output port is configured to transmit the random unique identifier to the second storage location. In one embodiment, the second location is a database associated with the importer. In another embodiment a copy of the RUID sent to the second storage location is kept in a database associated with the importer but the RUID is sent to a patient or to a medical record database that is not associated with the importer and does not have to reference the importer's database in order to retrieve the file from the first storage location. In one embodiment, the random unique identifier generator is part of the importer. In another embodiment, the random unique identifier generator is part of the first storage location. In another embodiment, a portion of the random unique identifier generator is part of the importer and a portion of the random unique identifier generator is part of the first storage location. The portions communicate and may negotiate with each other over a communication channel to determine a RUID for the file.

In another aspect, the invention relates to a method for storing data in a repository. The method comprises receiving, by an importer, data, generating an identifier associated with the data, the identifier including a substantially random unique identifier, transmitting the data to a repository and transmitting the identifier to a location separate and distinct from the repository and the importer. In one embodiment, the data includes a medical image. In another embodiment, the method further includes encoding the data to a coded file. In another embodiment, the coded file includes a lossy compressed image. In another embodiment, the coded file includes a wavelet-coded image. In another embodiment, the coded file is a standards-based format. In another embodiment, the coded file conforms to the JPEG2000 standard. In another embodiment, the step of requesting the data further comprises requesting the data from the repository using a standards-based protocol. In another embodiment, the method further includes requesting the image from the repository using the identifier. In another embodiment, the method further includes generating a new identifier associated with the data after the data has been requested. In another embodiment, the method further includes storing the identifier in a manner compliant with HIPAA. In another embodiment, the method further includes restricting access to the identifier at the location. In another embodiment, the method further includes prohibiting browsing of a directory in the repository in which the data is located. In another embodiment, the identifier includes an address of the data in the repository. In another embodiment, the random unique identifier corresponds to a directory in the repository in which the data is located. In another embodiment, the location is a hospital information system. In another embodiment, the location is associated with a patient with whom the data is associated.

In another aspect, the invention relates to a method for storing a manifest in a repository. The method includes receiving, by an importer, one or more images from an image source, generating a respective set of identifying data associated each of the one or more images, and generating a manifest including the respective set of identifying data associated each of the one or more images. The method also includes generating identifying data for the manifest, the identifying data including a substantially random unique identifier, transmitting the one or more images and the manifest to a repository, and transmitting the identifying data for the manifest to a location separate and distinct from the repository and the importer. In one embodiment, the manifest conforms to an XML standard. In another embodiment, the method the manifest conforms to a DICOMDIR standard, wherein the one or more images conform to the DICOM standard.

In another aspect, the invention relates to an importer for preparing data to be stored in a repository. The importer includes a receiver module, at least a portion of an identifier and a transmitter module. The receiver module is configured to receive data from an image source. The at least a portion of an identifier generator module is configured to negotiate an identifier associated with the data, the identifier including a substantially random unique identifier. The transmitter module is configured to transmit the data to a first location and to transmit the identifier to a second location, wherein the first and second locations are separate and distinct from each other and are accessible by a user without intervention by the importer. In one embodiment, the import further comprises an encoding module configured to encode the data to a coded file. In another embodiment, the importer further includes a manifest generator module configured to generate a manifest including the identifier of the data.

In another aspect, the invention relates to a system for storing an image in a standards-based repository. The system includes an image processor, a storage location, and a client agent. The image processor is configured to receive an image from an image source, to generate a substantially random unique identifier associated with the image and to format the image to be compatible with a standards-based repository. The storage location is separate from the standards-based repository and configured to receive and to store the substantially random unique identifier. The client agent is configured to access the storage location to retrieve the substantially random unique identifier and to access the image from the standards-based repository using the unique identifier to locate the image.

### BRIEF DESCRIPTION OF THE DRAWINGS

The above and further advantages of the invention may be better understood by referring to the following description taken in conjunction with the accompanying drawing, in which:

FIGS. 1A and 1B are block diagrams of illustrative embodiments of a system to store and retrieve compressed images in a repository in accordance with the invention;

FIG. 2 is a block diagram of another illustrative embodiment of a system to store and retrieve compressed medical images in a hospital environment in accordance with the invention;

FIG. 3 is a block diagram of another illustrative embodiment of a system to store and retrieve compressed images in accordance with the invention;

FIG. 4 is a flow diagram of an illustrative embodiment of a process to store compressed images in accordance with the invention; and

FIG. 5 is a flow diagram of an illustrative embodiment of a process to retrieve compressed images stored in accordance with the invention.

### DETAILED DESCRIPTION

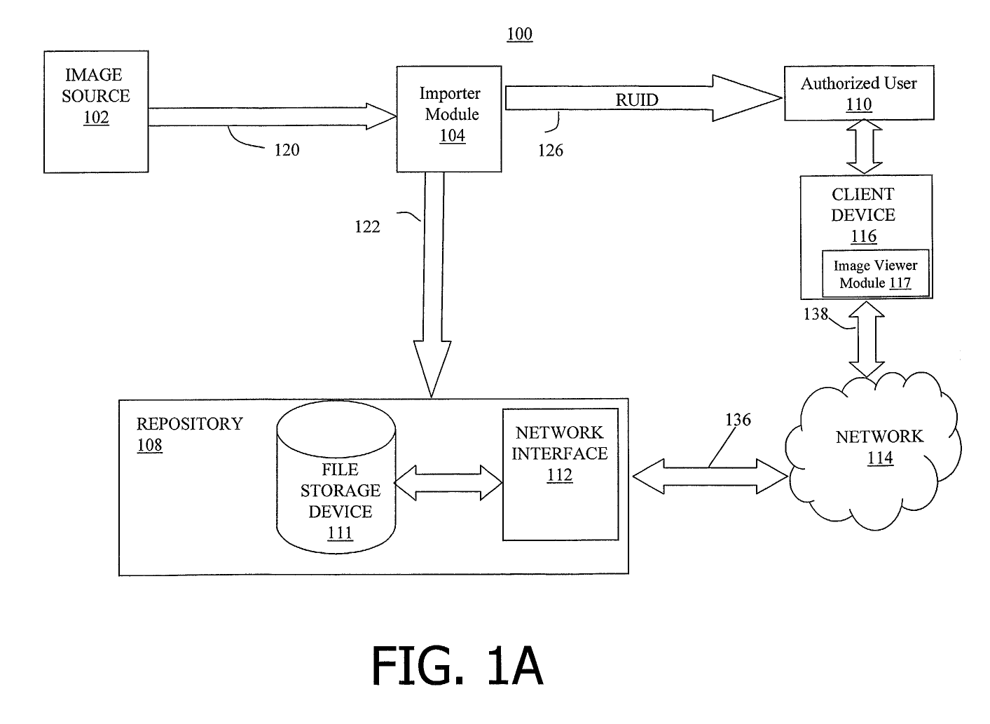

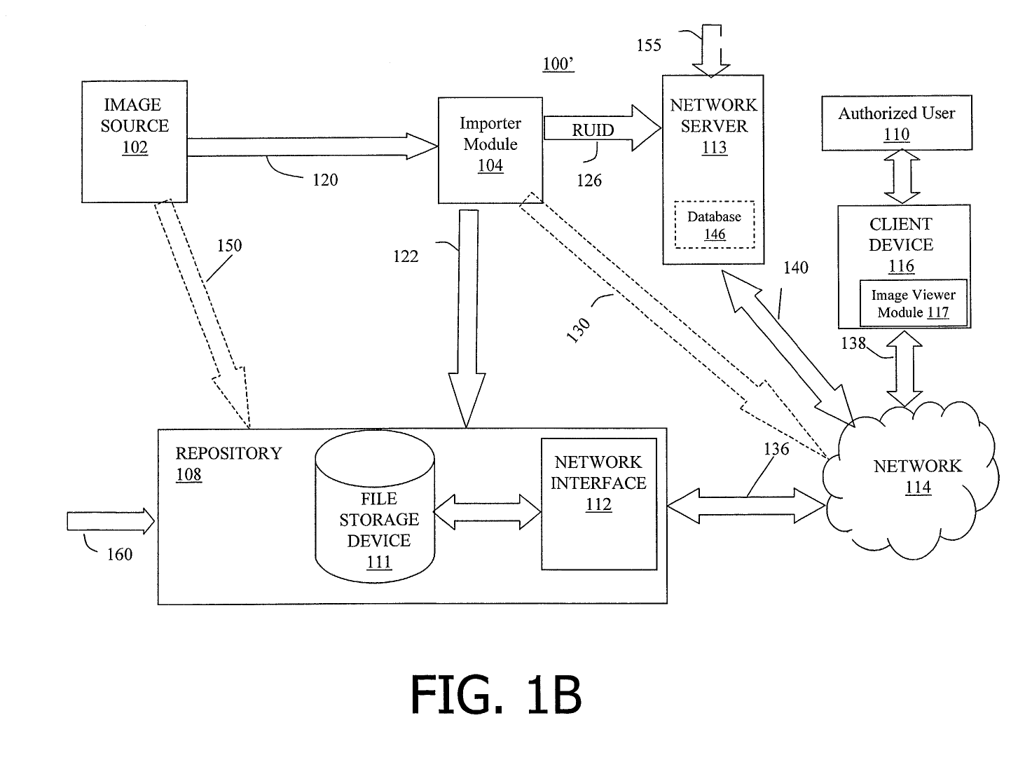

FIG. 1A is a diagram of an illustrative system 100 for storing and retrieving images in a repository according to the invention. The system 100 includes an image source 102, an importer module 104, a repository 108 representing a first storage location, and an authorized user 110, representing a second storage location. The repository 108 includes a file storage device 111 and a network interface 112. The system 100 also includes a network 114 and a client device 116. The client device includes an image viewer module 117. The importer module 104, the image viewer module 117 and all modules mentioned throughout the specification are implemented as a software program and/or a hardware device (e.g., server, computing device, ASIC, FPGA and the like)

The system 100 includes a first communication channel 120 between the image source 102 and the importer 104. The system 100 includes a second communication channel 122 between the importer 104 and the repository 108. The system 100 includes a third communication channel 126 between the importer 104 and the authorized user 110. The system 100 includes a fourth communication channel 136 between the repository 108 and the network 114. The system 100 includes a fifth communication channel 138 between the client device 116 and the network 114.

For example, the network 114 can be a local-area network (LAN), such as a company Intranet, a wide area network (WAN) such as the Internet or the World Wide Web, a Virtual Private Network (VPN) or the like. The communication channels 120, 122, 126, 130 (FIG. 1B), 136, 138, 140 (FIG. 1B), 150 (FIG. 1B), 155 (FIG. 1B) and 160 (FIG. 1B) and the network 114 represent a communication path that can be implemented through a variety of connections including standard telephone lines, LAN or WAN links (e.g., T1, T3, 56 kb, X.25), broadband connections (ISDN, Frame Relay, ATM), wireless connections and the like. The connections can be established using a variety of communication protocols and standards (e.g., HTTP, HTTPS, DICOM, HL7, NTFS, FTP, SSL, TCP/IP, RDP, IPX, SPX, NetBIOS, Ethernet, RS232, direct asynchronous connections and the like). In a preferred embodiment, the communications protocols used across communication channels 136 and 138 and the network 114 are standards-based protocols, and not proprietary, to facilitate universal client 116 access to images stored in the repository 108, as described in more detail below. In another embodiment, the communication channel 122 is proprietary. This embodiment allows the importer module 104 to have a different set of features and/or privileges than the clients 116 communicating over the network 114 using a standards-based protocol. For example, this can allow the importer module 104 to browse directories containing image files where the client 116 and other clients using the network 114 are prohibited from browsing.

In operation, the importer module 104 receives data from the image source 102 over the communication channel 120. The data received by the importer 104 can include both image and non-image data (e.g., text, patient information, image parameters and the like). The data can be transmitted and stored i) in “files”, ii) as streamed formats and/or iii) other non-file formats (e.g., DICOM and the like). Accordingly, although the illustrative embodiments deals primarily with image files, virtually any other data construct may be employed without deviating from the scope of the invention. The image source 102, also referred to as a modality, is a device that captures an image and/or image related data. For example, the image source 102 can be a computed tomography (“CT”) imager, a magnetic resonance (“MR”) imager, an ultrasound (“US”) imager, an X-ray imager, a computed radiography (“CR”) imager, a digital radiography (“DR”) imager, a secondary capture (“SC”) imager (e.g., a 3D reconstruction), a radiograph (“RG”) imager (e.g., radiograph captured by a film digitizer) and the like. The image source 102 can also be a camera, a video recorder a scanner and the like. If the image source 102 does not generate a digital image, a converter (not shown) is added to the output of the image source 104 to generate a digital image file for receipt by the importer 104.

In one embodiment, the importer 104 generates identifying data associated with that received image file. The identifying data includes an address representing a location and/or a path to the location where the client device 116 can access that received image file. The address can be, for example, a URL. In one embodiment, as described in more detail below, the identifying data contains a substantially random unique identifier therein. The unique identifier is substantially random because it is generated such that there is low or no probability of an unauthorized user on the network 114 accidentally or intentionally generating the unique identifier if that user does not know what it is. In another embodiment, the repository 108 generates the identify data for the image file.

In another embodiment, both the importer module 104 and the repository 108 are involved in generating the identifying data. In this embodiment the importer 104 and the repository 108 negotiate what the identifying data will finally be. For example, in one embodiment, the importer module 104 contains a storage (e.g., persistent memory, database, hard drive or other physical device and the like) of all identifying data for images previously stored in the repository 108 or elsewhere. The repository 108 generates initial identifying data for a new image the importer 104 wants to store in the repository. The identifying data in this embodiment contains a RUID. The repository 108 transmits this initial identifying data to the importer 104. The importer checks for collisions with any previously stored images with the same or very similar identifying data. If there are collisions, the importer 104 requests that the repository 108 generate different identifying data for the image. If there are no collisions, the importer 104 accepts the identifying data from the repository 108.

The importer 104 transmits the identifying data to the second storage location, in the illustrated embodiment, an authorized user 110. In addition to the examples above, the communication channel 126 can represent a facsimile machine, printer, email and the like that prints out and/or displays the identifying data for retrieval by the authorized user 110. The importer 104 can also deliver the identifying data as an audio message, over the phone, through speakers and the like. The authorized user 110 is a user who is authorized to have access to the received image. For example, in an embodiment where the image is a medical image, the authorized user 110 can be the technician capturing the image with the image source 102, a physician who order the image, a primary care physician of the patient associated with the image, the patient, and the like. The authorization process can be any accepted authorization, for example, passwords, biometric authentication, passing of the piece of paper with the identifying data from one person to another recognized authorized user, and the like. The importer 104 can authorize a user or can receive indication from a trusted source that the user is an authorized user 110.

In some embodiments, the importer 104 converts the image file from the received format (e.g., DICOM and the like) to a different format (e.g., XML, JPEG2000 and the like). To facilitate enterprise distribution of image files, the importer 104 creates a smaller or streamable, wavelet coded image. In some embodiments, the importer 104 compresses the size of the image, for example taking advantage of redundant information in the image. In some embodiments, the importer converts the received image file to a coded image that contain less information than the source image (e.g., DICOM) and may be referred to as a lossy image. Preferably, the resolution of the lossy image is high enough to perform its intended function (e.g., using it for medical evaluation). In one embodiment, the compression algorithm is a standards-based compression algorithm.

The importer 104 transmits the received image file (e.g., DICOM), or the coded image file (e.g., JPEG2000) if applicable, to the first storage location, in the illustrated embodiment, the repository 108. The repository 108 represents any storage device/system accessible by the client device 116 via the network 114. The repository 108 can be, for example, a file server, a RAID system and the like. The file storage device 111 can be a magnetic storage, device, an optical storage device, a non-volatile memory device and the like.

In addition to medical images, the repository 108 can optionally also store patient study descriptor information. The term patient study refers to a collection of data and images related to a particular patient at a particular time. In one embodiment, the patient study descriptor information, also referred to as a manifest, is stored as an XML file, an HTML file and/or the like. In another embodiment, where the collection of stored images is a collection of DICOM images, the manifest is stored as a DICOM file known as DICOMDIR. As described in more detail below, in one embodiment, a random unique identifier identifies the manifest (e.g., XML file and the DICOMDIR file).

DICOMDIR is a type of manifest file that places internal constraints on the elements in the manifest due to the DICOM standard. For example, the file identifiers in DICOMDIR are limited to 71 characters and uses certain characters (e.g., uppercase characters, integers, ‘/’, and ‘_’). Further, the manifest file name itself must be “DICOMDIR”. There are several ways to deal with any DICOM restrictions to use a DICOMDIR manifest with this invention. In one embodiment using DICOMDIR, a study folder that uses a RUID can be created and the files can be copied from the DICOM Device or CD and placed in this folder. The files can be retrieved by reading the DICOMDIR manifest and then copying the individual files back out to a local file volume to be read by standard DICOM software. The file structure is, for example:

http://hostname/Adoiuj97879aE4/DICOMDIR

http://hostname/Adoiuj97879aE4/FILEROOT/STUDY1/SERIES1/IMAGE1.DCM

http://hostname/Adoiuj97879aE4/FILEROOT/STUDY1/SERIES2/IMAGE1.DCM

http://hostname/Adoiuj97879aE4/FILEROOT/STUDY1/SERIES2/IMAGE2.DCM

The DICOMDIR file contains file IDs like “/FILEROOT/STUDY1/SERIES2/IMAGE1.DCM”. In this illustrative embodiment, the RUID is a file directory location (e.g., Adoiuj97879aE4) to copy a DICOMDIR file and its associated DICOM objects. No internal modifications are made to the DICOMDIR object. In another embodiment, the DICOMDIR file and associated subdirectories can be combined into a single file such as a zip or tar file. The file name contains a RUID, for example, http://hostname/amicas-patients/ByiouKDJ9090Ss/jlkj09234aA.zip. This file contains, after unzipping or untarring, the entire directory hierarchy referred to by the DICOMDIR. Again, no internal modifications are made to the DICOMDIR object.

In another embodiment, the DICOMDIR file contains can be mapped to RUID references in several ways. For example, DICOMDIR allows private elements, which can contain the full RUID references for each file ID. The retrieval/copying software module (not shown) retrieves the DICOM objects via their RUID and places them in files with names represented by the DICOMDIR file IDs. In this embodiment, the retrieval/copying software module performs this remapping. In another embodiment, the DICOMDIR file IDs could contain the RUID pathnames. These file names may be longer than 71 characters and may contain forbidden characters. The copy/retrieval software module generates new DICOMDIR file IDs as part of the copy process so that these images could be read by standard DICOM software. In another embodiment, a separate manifest file keeps the mapping of the DICOMDIR file IDs to the RUID path names. The copying process copies the image or other data objects with RUIDs into the DICOMDIR file IDs as a separate procedure.

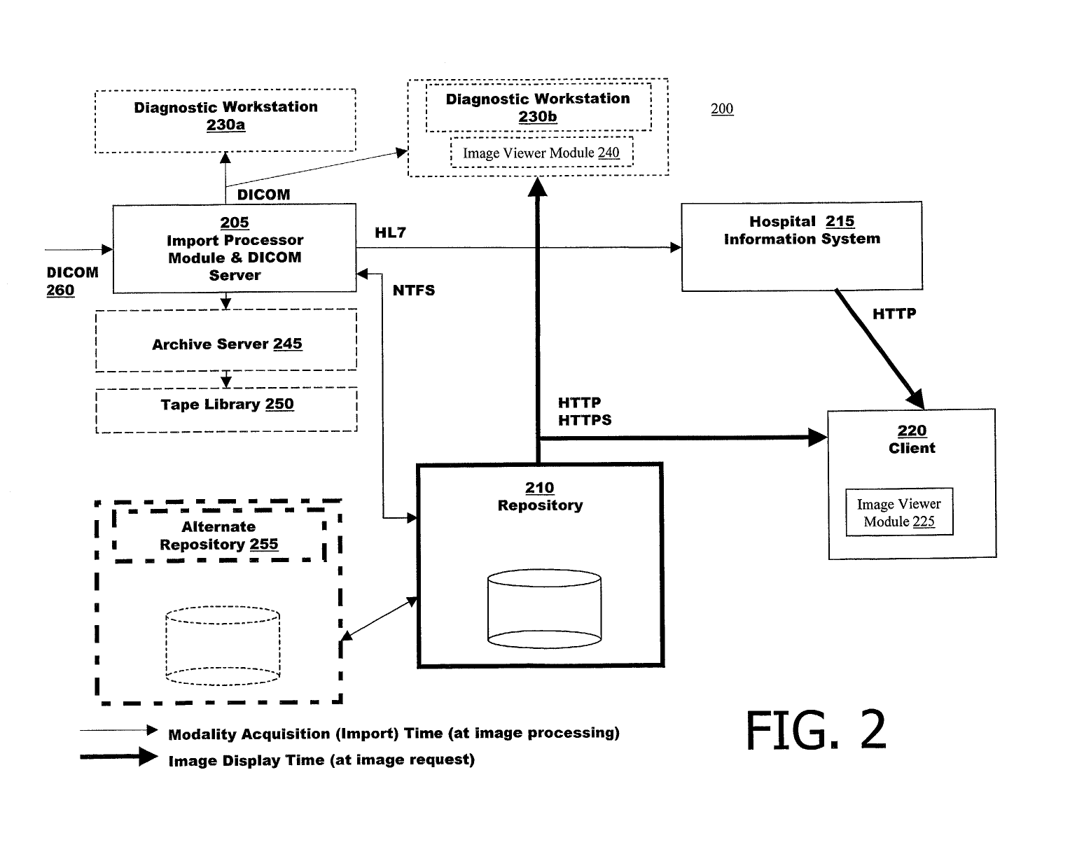

An average patient study can include fifty images. Transmitting identifying data for fifty images to the authorized user 110 may overwhelm the authorized user 110. In one embodiment, instead of the identifying data for fifty images, the importer 104 transmits identifying data of a manifest containing the identifying data for the fifty images in the study. As explained in more detail below, the image viewer 117 retrieves the manifest from the repository 108 using the identifying data of the manifest and, upon opening the manifest, has the identifying data for each of the images and can retrieve the images as the user 110 requests. In other embodiments, the manifest is stored in multiple formats, for example XML, HTML and the like, so that different viewers (e.g., 117 (FIG. 1A), 240 (FIG. 2)) using different file formats can access the same information. The general structure of a manifest, in an embodiment where it is stored as an XML file, is:

<Study>

<Patient attributes . . . >

<Study attributes . . . >

<Series attributes . . . >

<Image attributes . . . >

</Study>

For example, a study with two series of images, with one image in the first series and one hundred images in the second series, the structure is:

<Study>

<Patient attributes . . . >

<Study attributes . . . >

<Series attributes . . . >

<Image attributes . . . >

<Series attributes . . . >

<Image attributes . . . >

<Image attributes . . . >

. . . and 98 more Image attribute objects

</Study>

The indentation here is done for clarity—there is no nesting of the attributes. The order of the elements reflects the order of presentation in the study although this can be easily recalculated by the client 116. When the Study descriptor (i.e., XML file, manifest) is arranged in a particular way, a Web server (e.g., network interface 112) can deliver content to the viewer 117 in a faster manner. In particular, the manifest should support streaming by putting the elements that are required to display a user interface or GUI on the first screen toward the beginning of the study descriptor file. The addition of a directory to the contents of the study descriptor file, also written early in the file, enables the client 116 to take advantage of server protocols that accept beginning and end byte ranges as an argument, such as HTTP 1.1.

In one embodiment, the Patient attributes can include, for example, a normalized patient ID, a station ID, a normalized patient name, a modified date and a patient file root. Normalization in this embodiment means that the alphabetic characters are mapped to upper case and that spaces are removed. The normalized patient ID is derived from a study attribute (which contains the value from DICOM). The station ID is an integer that uniquely identifies the server containing the importer 104. This number is assigned when the server software is installed. The normalized patient name is also derived from the study attribute (which contains the DICOM value). The modified date is the date and time that the importer 104 completed its process for the last study that was imported for this patient. It is identical to the study's attribute field if that study was the last one imported. The patient file root is the file root of the patient directory in the repository 108. In one embodiment, studies for a patient are in subfolders of this folder. In one embodiment, the patient file root is a random study identifier, as negotiated between the Importer 104 and the Repository 108. In another embodiment, this random study identifier can include the IP address of a server (e.g., repository 108) or even a file root on that server. In yet another embodiment, there would be a potentially unlimited number of different patients, manifests or images beyond this file root in order to assure that random inquiries to that file root have an insignificant chance of breaking security. In other words, subdirectories and/or file names are also generated using a RUID so that even if an authorized user 108 knows of this root directory because he is authorized to have this information, he still cannot randomly or intentionally locate images and/or manifests contained within this root directory without having the exact locations, including the RUIDs for each file he wants to retrieve.

The Study attributes can include, for example, a study ID, a station ID and a study UID. The study ID is the numeric ID of the study assigned by the importer 104. The station ID is the numeric ID of the server containing the importer 104. The study UID is a concatenation of a machine ID, a patient hashcode and/or RUID, the station ID, and the study ID, separated by “.” (e.g. 102.5x258FR02yP29MI5sk.102.12526). The Series attribute can include, for example, a series UID. The series UID is a concatenation of the study UID and the series number separated by “.” (e.g. 102. 5x258FR02yP29MI5sk.102.102.12526.26012). The image attributes can include, for example, an image UID and a MIME type or file extension. The image UID represents the UID of the image data. This is a concatenation of the series UID and the image number separated by “.” (e.g. 102. 5x258FR02yP29MI5sk.102.12526.26012.107661). The image UID can also include a RUID (e.g. 102. 5x258FR02yP29MI5sk.102.12526.26012.g510yDW7s66jk1). The MIME type and/or file extension identifies the compression algorithm the importer 104 used to compress that particular image. For example, for a compressed file using the JPEG2000 standard, the file extension is “JP2” and for a manifest file the file extension is XML. In one embodiment, the identifying data that the importer 104 transmits to the authorized user 110 contains address information, for example a URL.

In one embodiment, using a manifest, there are two parts of a URL for an image. The first part is the root directory where the image and/or manifest is stored. In the illustrated embodiment, this is the repository 108. The second part is a relative URL path to the manifest. For example, in one embodiment the relative path consists of four segments, a patient root, a study root, a manifest file name, and a file extension. In one embodiment, the relative path (i.e., the second part) includes a random unique identifier. The RUID can be included in any part of the URL. For example, the RUID can be used for files names, directories, sub-directories and the like. For example, if the first part is “http://images.myhospital.org/amicas-patients/” and the second part is “ABC80980980AkjljUI14554.XML” then the complete URL path is “http://images.myhospital.org/amicas-patients/ABC80980980AkjljUI14554.XML”. This permits a site to change the network address of the repository 108 without having to modify or change each stored reference to the images or manifest.

When the authorized user 110 wants to retrieve the image file, or manifest, the authorized user 110 uses the client device 116. The client device 116 is a computing device that can communicate with the network 114. The client device 116 can be for example, a personal computer, a general workstation, a radiology workstation, a set top box, a wireless mobile phone, a handheld device, a personal digital assistant, a kiosk and the like. The client device 116 includes the image viewer module 117. The image viewer 117 can be a separate application program or can be a plug-in to a Web browser application on the client device 116. In one embodiment, the viewer is a JAVA-based plug-in. The client device 116 communicates over the network 114 to request a desired image file or patient study. In one embodiment, the protocol used by the client device 116 and the network interface 112 is a standards-based protocol (e.g., HTTP, HTTPS and the like).

The client device 116 includes the identifying data with the request for the image file, for example, the identifying data for a manifest of a study for a patient with the ID number 359762 is “http://192.168.3.2/Amicas_patients/359762/adEDJkd9898.XML”. The repository 108 transmits the requested image file or manifest to the client device 116 for display using the image viewer 117. If an image is retrieved, the image viewer 117 displays the image. If a manifest is retrieved, the image viewer displays a GUI, for example a slide bar, representing all of the series in the study and all of the images in the series contained in the manifest. The user selects an image using the GUI, for example moving the slide bar to the first image in the first series. The viewer 117 uses the manifest to create the URL for the desired image. For example, as described above, the viewer uses the manifest to determine that the URL for the desired image is “http://192.168.3.2/Amicas_patients/359762/7Ful3xKA74h09.JP2”. The viewer 117 requests this image and displays it upon receipt. Though in the illustrative example the RUIDs are used for the manifest and image names, the RUID can also be used at any different level, alone or in combination. For example, other URLs can include “http://192.168.3.2/Qa95msdDg39jhdV/3597627/Image1.JP2”, http://192.168.3.2/Amicas_patients/3Ueo56kDW9547/Image1.JP2”, http://192.168.3.2/Qa95msdDg39jhdV/33Ueo56kDW9547/7Ful3xKA74h09.JP2” and the like. Further, though the illustrative file paths may imply a hierarchy (e.g., all images associated with a patient in the patient's ID subdirectory), a hierarchy is not necessary and the identifying data can represent a flat address space.

As described above, another way to make the image files secure on a highly accessible repository is to include random data, for example a random unique identifier, in the identifying data that the importer 104 transmits to the authorized user 110. In one embodiment, the RUID represents the location of the image file on the file storage device 111, for example a directory or subdirectory. In another embodiment, the RUID represents the name of the image file needed for retrieval. The RUID can be, for example an alphanumeric string, such as 35SZ9249HF2175D54NG4. The client device 116 includes the RUID with the request for the image file, for example https://123.45.67.89/amicas-studies/35SZ9249HF2175D54NG4.JP2. With a large enough data word, the search space makes the probability very low that someone can accidentally or even intentionally identify and retrieve an image. For example, a 128 bit random identifier allows 3.40 e+38 possibilities. Even with one billion image files, 1.0 e+9, the amount of used combinations as a percentage of unused combinations is negligible, or more specifically, about 2.94e−28 percent.

In one embodiment, the network interface 112 does not permit browsing of the directory in which the image file or manifest is located. For example, the network interface 112 does not permit browsing of the Amicas_patients directory of the address http://192.168.3.2/Amicas_patients/359762/adEDJkd9898.XML. Thus, any authorized user 110 with the identifying data can retrieve the manifest, but anyone with access to the repository 108, because for example it is an ordinary Web server on the Internet, cannot browse the Amicas_patients directory and retrieve medical images that might look interesting.

FIG. 1B is a diagram of an illustrative system 100′ for storing and retrieving compressed images in a repository according to the invention. System 100′ includes an additional network server 113 as its second storage location. The network server can include an optional database 146. In this embodiment, the importer 104 transmits the identifying data, in one embodiment including a RUID, to the network server 113 or the optional database 146 for storage. The client device 116 communicates with the network server 113 and/or database 146 to retrieve the identifying data for image files and/or manifest that an authorized user 110 wants to access. In this embodiment, the network server 113 and/or database 146 can act as the gatekeeper to determine if the user using the client device 116 to access identifying data for an image or manifest is authorized to do so. In one embodiment, the database 142 is a hospital medical records system. In one embodiment, the protocol used by the client device 116 and the network server 113 is a standards-based protocol (e.g., HTTP, HTTPS and the like).

In one embodiment, the system 100′ can include an optional communication channel 140 that is used in place of or in addition to the second communication channel 122 and/or the third communication channel 126. In another embodiment, the system 100′ can include an optional communication channel 150 between the image source 102 and the repository 108. In another embodiment, the system 100′ can include another optional communication channel (not shown) between the image source 102 and the network 114, such that the images are transmitted from the image source 102 to the importer module 104 and/or to the repository 108 via the network 114. In yet another embodiment, the importer module 104 is included in the image source 102.

In other embodiments, the network server 113 and/or the repository is separate and distinct from the importer module 104 because, for example, each is controlled and/or administered by a separate entity, each is manufactured by a separate entity, each is unrelated to the other, each represents different business entities, each are at different physical locations, each communicate using different protocols and/or the like. In the illustrated embodiment, the network server 113 receives other RUIDs from other importer modules (not shown) that are unrelated to importer module 104 over communication channel 155. Similarly, the repository 108 receives other data from other importer modules (not shown) and/or image sources (not shown) that are unrelated to importer module 104 over communication channel 160.

The Health Insurance Portability and Accountability Act (HIPAA) addresses the privacy and security of patient data. For HIPAA compliance, the system 100 and/or 100′ can implement, for example, administrative procedures that enable administrators to identify individuals who access protected health information, providing the ability to track who is responsible for any breaches of privacy. In one embodiment, the repository 108 requests additional information beyond the RUID, such as a password from the user 110, for access to the image file. In another embodiment, the importer 104 negotiates a different RUID with the repository 108 each time the file is requested, so that if, for example, the RUID remains stored in the client device 116 memory, another unauthorized user cannot locate the RUID in the client 116 memory and use it to access the associated image file. In another embodiment, an image has several RUIDs, one for each of the authorized users 110 that are allowed to access the image. When an image is accessed, the authorized user 110 is identified by the RUID used to access the image. Similarly, for example if the system 100′ uses a manifest to group all of the images for a patient study, a separate manifest can be generated for each user 110, each with a different RUID. When a manifest is accessed, the authorized user 110 is identified, because that user 110 is associated with a particular RUID, and all of the image RUIDs are re-negotiated to prevent access using the client 116 memory. In another embodiment, the image RUIDs are hidden from browsing below the directory that is identified by the manifest RUID. In this embodiment for example, the identifying data for each of the images is a relative URL from the manifest directory. Once the user 110 accesses the manifest, it is subsequently deleted from the repository 108. Because the images are found using a URL relative to the manifest, once the manifest is deleted, the path using the RUID of that particular manifest will no longer work.

In another embodiment, a master copy of the manifest is generated. The master copy of the manifest can be stored, for example, in the importer 104 or the repository 108 in persistent storage. The importer 104, the repository 108 and/or a separate copying module (not shown) generates a read copy of the master copy of the manifest, along with a RUID. When a user 110 wants to retrieve the manifest, the importer 104 or the network server 113 transmits the RUID of the read copy to the user 110. The read copy is subsequently deleted after the user 110 reads it. This deletion can be executed, for example, after a single read, after a predefined time limit expires and/or the like. The importer 104, the network server 113, the repository 108 and/or a separate copying module (not shown) can initiate this deletion, using for example, proprietary software, the HTTP(S) DELETE method and the like. Similarly, in another embodiment, master copies of the manifest and all of the images are generated. In this embodiment, the read copies of the manifest and all of the images each receive their own RUID and are deleted subsequent to retrieval.

FIG. 2 is another illustrative embodiment of a system 200 to store and retrieve compressed medical images in a hospital environment in accordance with the invention. The system 200 includes an importer module 205, a repository, 210, representing a first location, a hospital information system (HIS) module 215, representing a second location, and a client 220. The client 220 includes an image viewer module 225. The modules enclosed in dashed lines represent optional modules to enhance the illustrated embodiment. Optional modules for the system 200 includes two diagnostic workstations 230a and 230b, generally referred to as 230. The second diagnostic workstation 235b includes an image viewer 240. The system 200 can also include an archive server 245, a tape library 250 and an alternate repository 255.

As shown, the thin arrows represent signal paths when the import processor 205 processes an image for storage. In operation, the importer 205 receives one or more images from one or more modalities (not shown). The importer 205 receives the one or more images in a DICOM format 260. The importer 205 creates two elements for each image. The first element is a compressed file of the image that the importer 205 transmits to the repository 225 for storage and retrieval. The second element is a unique file identifier (i.e., identifying data) associated with the compressed image file or a manifest that references a related set of images. The importer 205 transmits the unique file identifier to the hospital information system 215 complying with, for example, the HL7 standard. Once the importer 205 generates these two elements, the importer 205 is no longer needed to retrieve the stored information.

If there are multiple images that are related, for example all part of the same patient study, the importer 205 generates a secure meta-data file descriptor that is compatible with standards-based Web servers. For example, using the information from the DICOM format 260, the importer 205 generates a manifest as an XML file. The file descriptor (e.g., manifest) can be stored in a secure database or, as shown in this embodiment, as an element of a medical record in the hospital information system 215. In another embodiment, the importer 205 transmits the manifest to be stored in the repository 210. In this embodiment, the importer 205 transmits the unique file identifier (i.e., identifying data) associated with the manifest to the hospital information system 215. The identifying data for each of the images is stored in the manifest, on the repository, thus the HIS 215 only needs to store one unique identifier (i.e., that of the manifest) to control access to the entire patient study. The image viewer 225 requests the file descriptor (that points to the manifest) from the HIS 215 and can efficiently retrieve the manifest and images associated with the imaging study (i.e., patient study) from a standards-based archive, for example, repository 210.

By encoding the coded image file and/or the unique file identifiers and/or the metafile descriptors (e.g., manifest) with a random code (e.g., RUID), the security management can be separated and shifted away from the storage management. Therefore, the importer 205 can pass security management to an electronic medical record (EMR) system (e.g., HIS 215) and storage management to a storage management service (e.g., repository 210). In one embodiment, the importer 205 keeps a database of unique file identifiers as a cross-reference or backup. This backup database can be stored, for example, on the importer 205, on the archive server 245, on the tape library 250 and the like. In addition to the repository 210, the importer 205 can also store copies of the DICOM image or the direct image from the modality (e.g., the uncoded and/or lossless version of the image) on the archive server 245 and/or tape library 250. The archive server 245 and/or tape library 250 can also be used for redundancy in a disaster recovery situation. For example, the archive server 245 and tape library 250 and/or the alternate repository 255 can represent redundant storage of images and/or manifests that are physical secure (e.g., not accessible over the network 114 or any public communication channel, and are located in a locked and secure area so that there is no chance of unauthorized access. In another embodiment, the archive server 245 and tape library 250 and/or the alternate repository 255 can respond to standard DICOM and/or Web protocols themselves, so they can be accessed in a disaster recovery situation.

The thick arrows represent signal paths when a user using the image viewer module 225 on the client 220 retrieves an image. The viewer 225 obtains the second element, the file identifier, from the HIS 215. The HIS 215 controls access to the file identifier using well-known authentication/authorization tools. Once the viewer 220 has the unique file identifier, the viewer 225 retrieves the image file or the manifest, using the identifier, from the repository 210. If the identifier is associated with an image, the viewer 225 retrieves the image and displays it on the client 220. If the identifier is associated with a manifest, the viewer 225 retrieves the manifest and displays, for example, a list of the available images associated with that manifest, using a GUI. The user selects an image from the list using the GUI and the viewer 225 uses the manifest to obtain the unique file identifier associated with the selected image. The viewer 225 retrieves the image from the repository 210 using the obtained identifier and displays it on the client 220. In the illustrated embodiment, all communication between the viewer 225 the HIS 215 and the repository 210 comply with the HTTP(S) standard.

The diagnostic workstations 230 represent, for example, radiology workstations to which the modality or importer 205 pushes DICOM images. A user of the workstation 230 can view whatever images have been pushed to that workstation 230. The second workstation 230b includes an image viewer module 240. Instead of pushing all of the DICOM images in a patient study, which takes up a large amount of bandwidth and may not be necessary if the user is not interested in viewing all of the images, the importer 205 pushes, or offers on-demand, a manifest of the patient study to the second workstation 230b. The viewer 240 retrieves the manifest and displays, for example, a list of the available images associated with that manifest, using a GUI. The user selects an image from the list using the GUI and the viewer 240 uses the manifest to obtain the unique file identifier associated with the selected image. The viewer 225 retrieves the image from the repository 210 using the obtained identifier and displays it on the workstation 230b. In the case of 230b, the preferred embodiment requests the manifest and/or images using the HTTP(S) protocol and the manifest and image files are delivered to viewer 240 using the HTTP(S) protocol with and without lossy compression.

The alternate repository 255 can be a backup or a secondary copy for the primary repository 210, such as a multiple disk RAID system. The alternate repository 255 can be independent from the primary repository 210, such as a separate third party storage facility, storing, for example, a portion of the images in a patient study. In this case the client 220 communicates with each repository 210 and 255 independently, depending on which repository has the desired image. The Alternate Repository 255 can be accessible, for example, using HTTP(S) and/or DICOM Protocols.

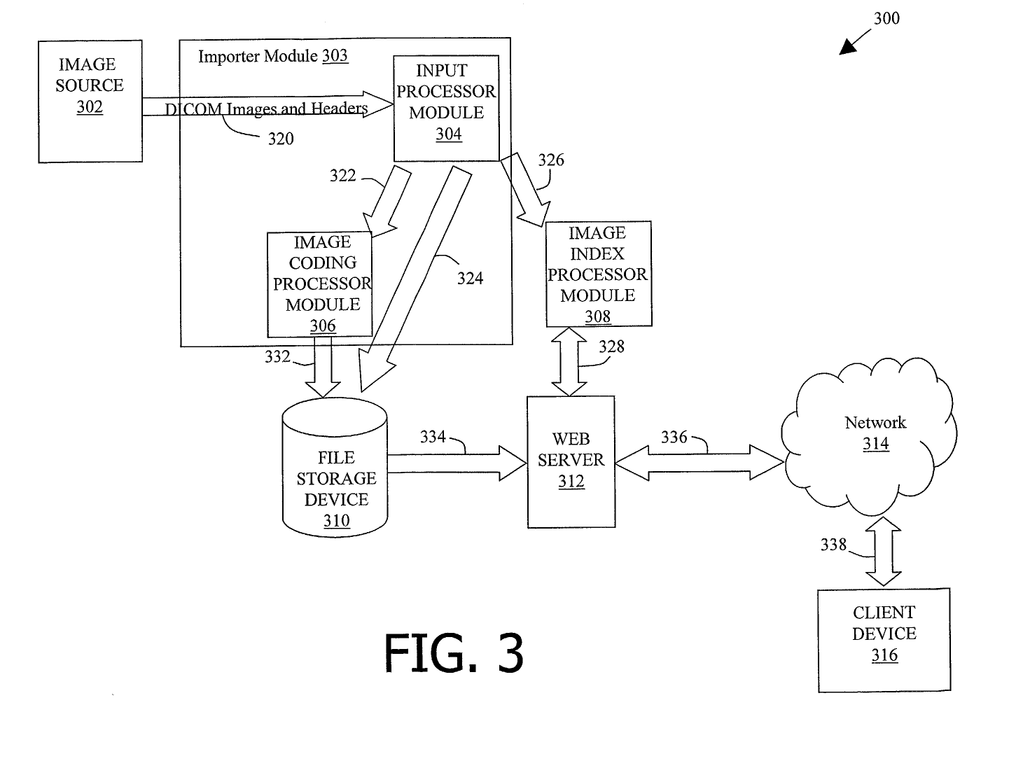

FIG. 3 is a diagram depicting a medical image storage and retrieval system 300 according to one embodiment of the invention. The system 300 includes an image source 302, an importer module 303, an image index processor module 308, representing a storage location for identifying data, a file storage device 310, representing a storage location for images and manifests, a Web server 312, and one or more client devices 316. The importer module 303 includes an input processor module 304 and an image coding processor module 306. The input processor 304 receives medical images and data from the image source 302 and optionally can preprocess the medical images. The preprocessing can include error checking and routing images to other systems, such as diagnostic workstations. In another embodiment, the preprocessing includes formatting the medical image data to comply with a standards-based image protocol (e.g., JPEG 2000). In one embodiment, this is done by the image coding processor module 306.

In one embodiment, the image source 302 generates (DICOM) images and headers. The image source 302 can be an X-ray system, a “Magnetic Resonance Imaging” (MRI) system, or other radiological system, for example. The output port (not shown) of the image source 302 is suitably connected to the input processor 304 through the DICOM bus 320. The DICOM bus 320 can be a parallel bus, a serial bus, a coaxial cable, a SCSI bus, Ethernet, RS232, or other suitable network connection scheme, for example. The DICOM bus 320 carries medical images and headers relating to the medical images to the input processor 304. The headers contain information relating to the medical images such as patient data, for example.

The input processor 304 imports the DICOM images and headers from the DICOM bus 320 and processes the received image data. In one embodiment, the input processor 304 divides the image and header information for efficient retrieval by the client device 316. The input processor 304 transmits the medical images through an image bus or memory buffer 322 to the image coding processor 306. In one embodiment, the input processor 304 converts the medical images received from the image source 302 to a format that is recognizable to the image coding processor 306.

The image coding processor 306 receives the medical images via the image bus 322. In one embodiment, the image coding processor 306 utilizes the standards-based JPEG 2000 Image Coding System. Alternative image coding systems can be utilized without departing from the scope of the invention. The image coding processor 306 transforms the medical images using the JPEG 2000 protocol. JPEG 2000 follows a similar progression to any transform technique for image compression.

The image coding processor 306 executes JPEG 2000 coding on the images received from the input processor 304. The image coding processor 306 is suitably connected to the file storage device 310. Once the medical images are processed by the image coding processor 306, they are transferred by the image coding processor 306 to the file storage device 310 via the bus 332. The file storage device 310 stores the images in either compressed or uncompressed format—or both using file identifiers that are available to the input processor 304. In alternative embodiments, the file identifiers can be a descriptive name, a path to the file location or, in the preferred embodiment a random unique identifier (RUID). In alternative embodiments, the file storage device 310 can be an optical storage device, a magnetic storage device, a tape drive, or other suitable data storage device.

In addition to medical images, the file storage device 310 also stores patient study descriptor information (e.g., manifest). The term patient study refers to data and images related to a particular patient at a particular time. The input processor 304 transmits the patient study descriptor information to the file storage device 310 via the patient study descriptor bus 324 using file identifiers that are available to the input processor 304. In alternative embodiments, the file identifiers can be a descriptive name, a path to the file location or, in the preferred embodiment a random unique identifier (RUID). The bus 324 and bus 322 from the importer 303 to the storage device 310 can be the same bus. The patient study descriptor information includes patient information such as patient name, age, sex, and time and date of study, for example. The patient study descriptor information is associated with the corresponding patient medical images that are stored in the file storage device 330. In one embodiment, the patient study descriptors can be included as part of the coded image file.

The input processor 304 transmits image headers and optional image meta-data related to the corresponding medical images to the image index processor 308 via the header bus 326. Portions of the image headers are indexed and stored in the image index processor 308 along with the descriptive, path-based or random file identifiers assigned to coded images 332 and patient study descriptors 324. The image index processor 308 can be part of, for example, a hospital information system and/or a database software program that is installed at the same time as the importer 303.

The image index processor 308 is connected to the Web server 312 through the bus 328. The Web server 312 interfaces to the network 314 via the bus 336. The Web server 312 receives requests for patient studies from one or more client devices 316 (only one shown for clarity). The Web server 312 transmits the requests to the image index processor 308 via the bus 328. The client device 316 is connected to the Web server 312 via network 314. The client device 316 can be a personal computer, a terminal, a workstation, a “Personal Digital Assistant” (PDA), a wireless device, or any Web compatible device for requesting and viewing patient studies including medical images. In one embodiment, the client device 316 includes a layer of client software that interfaces with the file storage device 310 using a network protocol (e.g., HTTP) via the client bus 338. In an alternative embodiment, the image index processor 308 is connected to the network 314 using a network server (i.e., a second Web server) that is separate from the Web server 312.

The network 314 can be, for example a local-area network (LAN), such as a company Intranet, a wide area network (WAN) such as the Internet or the World Wide Web, a Virtual Private Network (VPN) or the like. The communication channels (e.g., busses 320, 322, 324, 326, 328, 332, 334, 336 and 338 and the network 314 represent a communication path that can be implemented through a variety of connections including serial or parallel busses, standard telephone lines, LAN or WAN links (e.g., T1, T3, 56 kb, X.25), broadband connections (ISDN, Frame Relay, ATM), wireless connections and the like. The connections can be established using a variety of communication protocols and standards (e.g., HTTP, HTTPS, DICOM, HL7, NTFS, FTP, SSL, TCP/IP, RDP, IPX, SPX, NetBIOS, Ethernet, RS232, direct asynchronous connections and the like).

In operation, the system 300 functions as follows. A physician requiring a patient study inputs the request through the client device 316. The Web server 312 receives the request and transmits the request to the image index processor 308. The image index processor 308 retrieves the (RUID) identifiers of patient study descriptors and/or images of the requested patient studies and returns these to the user of client device 316 using either a standards-based or proprietary protocol. If there is more than one study, the user selects the desired study via the client device 316. The client device 316 then instructs—using standards-based protocols—the Web server 312 to request from file storage device 310 to transmit the requested medical images to the Web server 312 via the bus 334. The Web server 312 then transmits the medical images using standards-based protocols via the bus 336 The physician can then view and manipulate the images and data from the requested patient study using the client device 316.

In one embodiment, the client device 316 displays an HTML formatted Web page. The Web page allows a user to query the image index processor 308. A list of patient studies is then displayed on the Web page. The user then chooses a study from the list of studies displayed. The client device 316 then requests the images corresponding to the selected patient study from the file storage device 310. The images and data from the patient study are then displayed on the client device 316 where the user can study and manipulate them.

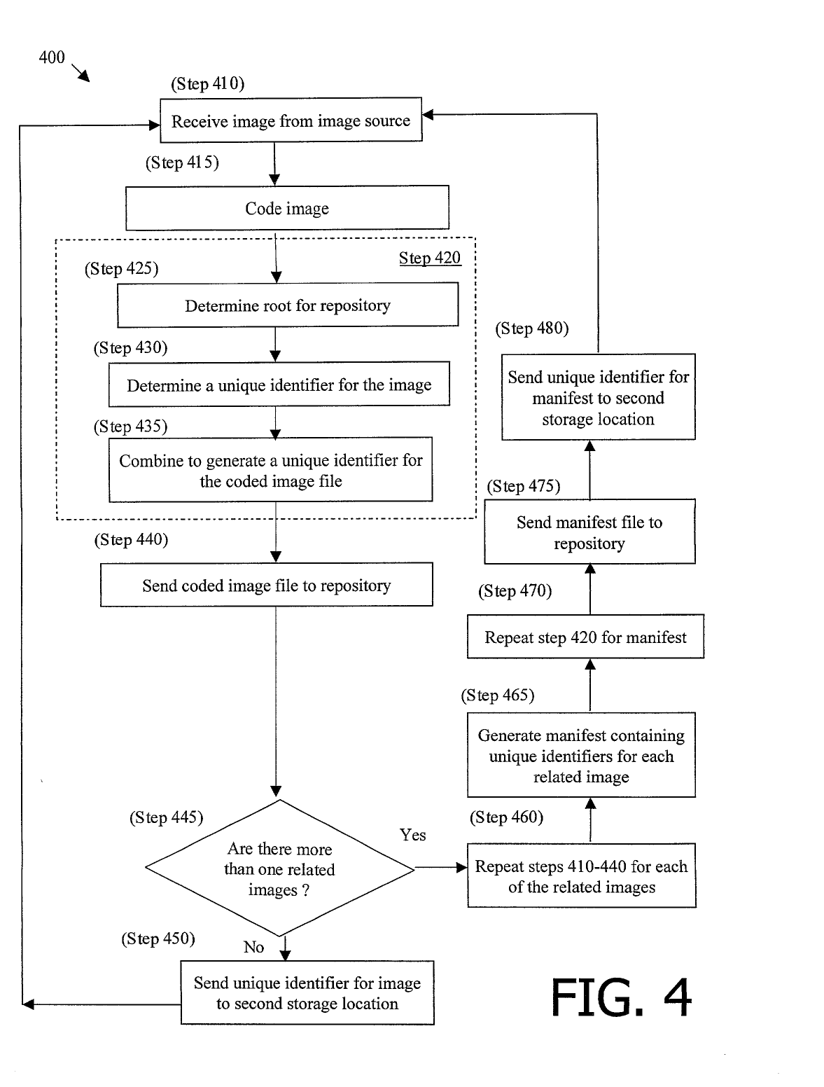

FIG. 4 illustrates an embodiment of a process 400 to store coded images in accordance with the invention. For illustration, the components of the system 100′ of FIG. 1B are used to describe the process 400. The importer module 104 receives (step 410) an image from the image source 102. The importer 104 codes (step 415) the image from the received format (e.g., DICOM) to a Web standard format (e.g., JPEG 2000). The importer 104 generates (step 420) a unique identifier for the coded image file. To do this, the generating step 420 is broken into three steps, step 425, step 430 and step 435.

The importer determines (step 425) the root for the repository 108. This can be, for example, the IP address of the network interface 112. The IP address can be combined with the directory in which the image will be stored on the file storage device 111. For illustrative purposes, the root is “http://192.168.3.2/amicas_images/”. In one embodiment, the root also contains a RUID. In one embodiment, an administrator enters this root information into the importer module directly, or into another computing device in communication with the importer 104, so that the importer 104 can retrieve this information. In another embodiment, where the importer 104 is optionally communicating with the network 114 directly via communication channel 130, the importer 104 can query the repository 108 directly and receive the root information from the repository 108. In another embodiment, the importer 104 requests a RUID from the file storage device 111 and uses that in subsequent steps.

The importer determines (step 430) a unique identifier for the image. As described with the manifest example above, the importer module 104 can concatenate several IDs together. The importer 104 can also generate a random alpha-numeric string that represents a random n-bit word. For illustrative purposes, the unique identifier for the image is a substantially random identifier “84jGe84BmAs9351D8YZw”. The importer 104 combines (step 435) the root for the repository, the unique identifier for the image and the file extension of the image file, by concatenating them, to generate the unique identifier for the compressed image file. For illustrative purposes, the unique identifier for the coded image file stored in the repository 108 is “http://192.168.3.2/amicas_images/84jGe84BmAs9351D8YZw.JP2”. With the unique identifier for the coded image file created, the importer 104 transmits (step 440) the coded image file to the repository 108 for storage.

The importer 104 determines (step 445) if there are more than one images related to each other, for example, as in a patient study. If the importer 104 determines (step 445) there is only the one image and there will be no others, the importer 104 transmits (step 450) the unique identifier for the coded image file to the network server 113 for retrieval by the authorized user 110. Likewise, if the embodiment does not use manifests for related images thus requiring the authorized user to obtain the unique identifier for each coded image file, the importer 104 transmits (step 450) the unique identifier for the coded image file to the network server 113. The importer waits to receive (step 410) another image from the image source 102.

If the importer 104 determines (step 445) there are a plurality of related images (e.g., same patient, same study, same series and the like), the importer 104 repeats (step 460) steps 410 through 440 for each of the related images. While the importer 104 processes (step 460) the related images, the importer 104 generates (step 465) a manifest (e.g., an XML file as described above) containing the unique identifiers for each of the coded image files. The importer 104 generates (step 470) a unique identifier for the manifest following the same steps in step 420. For illustrative purposes, the unique identifier for the manifest file is “http://192.168.3.2/Amicas_manifests/KT8H65YV476QMAU742G1.XML”. With the unique identifier for the manifest file created, the importer 104 transmits (step 475) the manifest file to the repository 108 for storage. The importer 104 transmits (step 480) the unique identifier for the manifest file to the network server 113 for retrieval by the authorized user 110.

In one embodiment, step 445 is not restricted to more than one related image. For example, a manifest is created even if there is only one image in order to maintain consistency and provide a faster user interface in the viewer 117 of the client 116. In another embodiment, the RUID represents a directory rather than a file (e.g., the directory has no associated MIME or file type). This directory allows all of the images and other files associated with and listed in a manifest to be listed in the manifest according to their explicit path. The presence of a RUID named directory, combined with the prohibition on directory browsing, means that there is low or no probability for an unauthorized user to reach the image files even if they have the manifest, as long as they do not have the current address of the manifest directory.

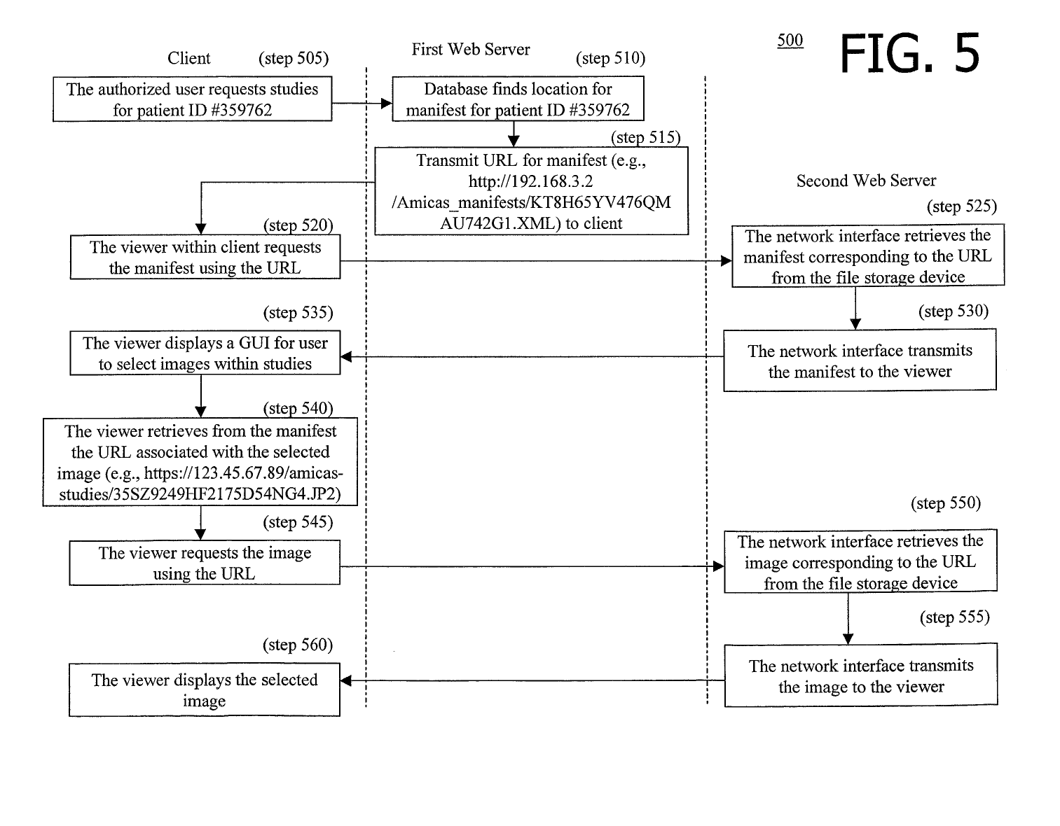

FIG. 5 illustrates an embodiment of a process 500 to retrieve images stored in accordance with the invention. For illustration, the components of the system 100′ of FIG. 1B are used to describe the process 500. In this case, the “client” is the client device 116, the “first Web server” is the network server 113, including the optional database 146, and the “second Web server” is the repository 108. The authorized user 110, using client device 116, requests (step 505) studies for patient ID #359762. The network server 113 authenticates that the authorized user 110 can request identifying data for a manifest for this patient ID.

The database 146 finds (step 510) the unique identifier, including location, for the manifest for patient ID #359762. The network server 113 transmits (step 515) the URL for manifest (e.g., http://192.168.3.2/Amicas_manifests/KT8H65YV476QMAU742G1.XML) to client 116. The viewer 117 within client 116 requests (step 520) the manifest using the received URL. The network interface 112 of the repository 108 receives the URL request and retrieves (step 525) the manifest corresponding to the URL from the file storage device 111. The network interface 112 transmits (step 530) the retrieved manifest to the viewer 117.

The viewer 117 displays (step 535) a GUI for the user 110 to select images within the study (or studies) contained in the retrieved manifest. The user 110 selects an image of interest. The viewer 117 retrieves (step 540) from the manifest the URL associated with the selected image (e.g., https://123.45.67.89/amicas-studies/35SZ9249HF2175D54NG4.JP2). The viewer 117 requests (step 545) the image using the retrieved URL. The network interface 112 of the repository 108 receives the URL request and retrieves (step 550) the image corresponding to the URL from the file storage device 111. The network interface 112 transmits (step 555) the retrieved image to the viewer 117. The viewer 117 displays (step 560) the selected image.

Equivalents

The invention can be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

What is claimed is:

1. A method for storing a data in a repository, the method comprising:
receiving, by an importer, data;
generating an identifier associated with the data, the identifier including a substantially random unique identifier;
transmitting the data to a repository; and
transmitting the identifier to a location separate and distinct from the i) repository and ii) the importer.

2. The method of claim 1 wherein the data includes a medical image.

3. The method of claim 1 further comprising encoding the data to a coded file.

4. The method of claim 3 wherein the coded file includes a lossy compressed image.

5. The method of claim 3 wherein the coded file includes a wavelet-coded image.

6. The method of claim 3 wherein the coded file is a standards-based format.

7. The method of claim 3 wherein the coded file conforms to the JPEG2000 standard.

8. The method of claim 1 further comprising requesting the data from the repository using the identifier.

9. The method of claim 8 further comprising generating a new identifier associated with the data after the data has been requested.

10. The method of claim 1 further comprising storing the identifier in a manner compliant with HIPAA.

11. The method of claim 1 further comprising restricting access to the identifier at the location.

12. The method of claim 1 further comprising prohibiting browsing of a directory in the repository in which the data is located.

13. The method of claim 1 wherein the identifier includes an address of the data in the repository.

14. The method of claim 1 wherein the substantially random unique identifier corresponds to a directory in the repository in which the data is located.

15. The method of claim 1 wherein the location is a hospital information system.

16. The method of claim 1 wherein the location is associated with a patient with whom the data is associated.

17. A method for storing a manifest in a repository, the method comprising:
receiving, by an importer, one or more files;
generating a respective set of identifying data associated each of the one or more files;
generating a manifest including the respective set of identifying data associated each of the one or more files;
generating identifying data for the manifest, the identifying data including a substantially random unique identifier;
transmitting the one or more files and the manifest to a repository; and
transmitting the identifying data for the manifest to a location separate and distinct from i) the repository and ii) the importer.

18. The method of claim 17 wherein the one or more files include medical images.

19. The method of claim 17 further comprising encoding at least one of the one or more files to one or more coded files.

20. The method of claim 19 wherein the one or more coded files are lossy compressed image files.

21. The method of claim 19 wherein the one or more coded files are wavelet-coded image files.

22. The method of claim 19 wherein the one or more coded files are standards-based formats.

23. The method of claim 19 wherein the one or more coded files conform to the JPEG2000 standard, thereby generating one or more JPEG2000 files.

24. The method of claim 23 wherein the manifest is included in the one or more JPEG2000 files.

25. The method of claim 17 further comprising requesting the manifest from the repository using the identifying data.

26. The method of claim 25 further comprising generating new identifying data associated with the manifest after the manifest has been requested.

27. The method of claim 17 further comprising storing the identifying data in a manner compliant with HIPAA.

28. The method of claim 17 further comprising restricting access to the identifying data at the location.

29. The method of claim 17 further comprising prohibiting browsing of a directory in the repository in which the manifest is located.

30. The method of claim 17 wherein the identifying data includes an address of the manifest in the repository.

31. The method of claim 17 wherein the random unique identifier corresponds to a directory in the repository in which the manifest is located.

32. The method of claim 17 wherein the location is a hospital information system.

33. The method of claim 17 wherein the location is associated with a patient with whom the one or more files are associated.

34. The method of claim 17 wherein the manifest conforms to an XML standard.

35. The method of claim 17 wherein the manifest conforms to a DICOMDIR standard.

36. The method of claim 35 wherein the one or more files conform to the DICOM standard.

37. An importer for preparing data to be stored in a repository, the importer comprising:
a receiver module configured to receive data from an image source;
at least a portion of an identifier generator module configured to generate an identifier associated with the data, the identifier including a substantially random unique identifier; and
a transmitter module configured to transmit the data to a first location and to transmit the identifying data to a second location,
wherein the first and second location are separate and distinct from each other and are accessible by a user without intervention by the importer.

38. The importer of claim 37 further comprising an encoding module configured to encode the data to a coded file.

39. The importer of claim 38 wherein the encoding module is further configured to compress the data to a lossy compressed image.

40. The importer of claim 38 wherein the encoding module is further configured to encode the data to a coded file that is a standards-based format.

41. The importer of claim 38 wherein the encoding module is further configured to encode the data to a coded file that conforms to the JPEG2000 standard.

42. The importer of claim 37 wherein the data includes a medical image.

43. The importer of claim 37 wherein the identifier generator module is further configured to generate a substantially random unique identifier including an address of the data at the second location.

44. The importer of claim 37 further comprising a manifest generator module configured to generate a manifest including the identifier of the data,
wherein the at least a portion of the identifier generator module is configured to generate the identifier associated with the data and with the manifest, the identifier associated with the manifest including a substantially random unique identifier, and
wherein the transmitter module is configured to transmit the data and the manifest to the first location and to transmit the identifier associated with the manifest to the second location.

45. The importer of claim 44 wherein the manifest generator module is further configured to generate a manifest that conforms to an XML standard.

46. The importer of claim 44 wherein the manifest generator module is further configured to generate a manifest that conforms to a DICOMDIR standard.

47. A system for storing a file in a standards-based repository, the system comprising:
an image processor configured to receive a file from an image source, to generate a substantially random unique identifier associated with the file and to format the file to be compatible with a standards-based repository;
a storage location separate from the standards-based repository, the storage location configured to receive and to store the substantially random unique identifier; and
a client agent configured to access the storage location to retrieve the substantially random unique identifier and to access the file from the standards-based repository using the unique identifier to locate the file.

48. The system of claim 47 wherein the image processor is further configured to format the image to be compatible with the JPEG2000 standard.

49. The system of claim 47 wherein the file includes a medical image.

50. The system of claim 47 wherein the storage location is a hospital information system.

51. The system of claim 47 wherein the image processor is further configured to generate a compressed image associated with the file.

52. The system of claim 51 wherein the compressed image is diagnostic quality.

53. The system of claim 47 wherein the storage location is further configured to generate a new substantially random unique identifier associated with the file after the file has been retrieved.

54. The system of claim 47 wherein the storage location is further configured to restrict access to the substantially unique identifier.

55. The system of claim 47 wherein the storage location is further configured to store the substantially random unique identifier in a manner compliant with HIPAA.

56. The method of claim 8
wherein the step of requesting the file further comprises requesting the file from the repository using a standards-based protocol, and
wherein the step of transmitting the file further comprises transmitting the image file using a standards-based protocol.

57. The method of claim 25
wherein the step of requesting the manifest file further comprises requesting the manifest file from the repository using a standards-based protocol, and
wherein the step of transmitting the one or more images and the manifest file image file further comprises transmitting the images using a standards-based protocol.

58. The method of claim 8
wherein the step of requesting the file further comprises requesting the file from the repository using a standards-based protocol, and
wherein the step of transmitting the file further comprises transmitting the image file using a proprietary protocol.

59. The method of claim 25
wherein the step of requesting the manifest file further comprises requesting the manifest file from the repository using a standards-based protocol, and
wherein the step of transmitting the one or more images and the manifest file image file further comprises transmitting the images using a proprietary protocol.

60. The importer of claim 37 wherein the data includes a medical image.
